(19) United States
(12) Patent Application Publication
(10) Pub. No.: US 2026/0318832 A1
(43) Pub. Date: Oct. 15, 2026

(54) METHOD AND DEVICE FOR SIMULTANEOUSLY TRACKING TWO EMITTERS

(71) Applicant: ABBERIOR INSTRUMENTS GMBH, Gottingen (DE)

(72) Inventors: Gerald DONNERT, Gottingen (DE); Matthias REUSS, Gottingen (DE); Joachim FISCHER, Karlsruhe (DE); Roman SCHMIDT, Gottingen (DE); Tobias ENGELHARDT, Karlsruhe (DE); Winfried WILLEMER, Bovenden (DE)

(21) Appl. No.: 19/104,278

(22) PCT Filed: Aug. 18, 2023
(86) PCT No.: PCT/EP2023/072826

§ 371 Date: Feb. 17, 2025

(30) Foreign Application Priority Data
Aug. 18, 2022 (DE) 10 2022 120 952.0

(51) Int. Cl. G01N 21/64

(52) U.S. Cl. CPC G01N 21/6456; G01N 21/6408

(57) ABSTRACT

The objective of the present disclosure is to provide solutions that enable simultaneous tracking of two optically distinguishable light-emitting particles or light-emitting units that are closely adjacent with high spatial and temporal resolution. The objective is solved by MINFLUX methods or by STED-MINFLUX methods or by a combination of both types of methods. Either a location of the first emitter is determined or locations of the first and second emitters are determined or a common mean location of both emitters is determined on the basis of different courses of intensity increase regions of an excitation light or an emission suppression light and associated measured values of the emission. This is repeated in chronological order with adjustments of the intensity increase regions to the current positions of the emitters.

### TECHNICAL FIELD

The present disclosure relates to the field of high-resolution light-optical microscopy. Specifically, it relates to methods and devices for simultaneously tracking the movements of several emitters, for example fluorescently labeled biological structures, which have a distance to each other during tracking which is smaller than the diffraction limit, with high time resolution.

### STATE OF THE ART

Interferometric scattering (ISCAT) microscopy is a well-known microscopy technique for tracking fast-moving particles. In the publication “Interferometric scattering microscopy reveals microsecond nanoscopic protein motion on a live cell membrane” (Taylor, R.W. et al., Nat. Photonics 13, 480-487 (2019). https://doi.org/10.1038/s41566-019-0414-6), an application of ISCAT microscopy to the tracking of proteins in membranes of living cells is described. With a temporal resolution of better than 20 μs, the method achieves a spatial resolution of better than 10 nm. In the method, the interference between reference light and light scattered by a marker, such as a gold nanoparticle, bound to the particle to be tracked, for example a biomolecule, is observed. Although the method enables a very good temporal-spatial resolution, it has the disadvantage that the markers to be used are comparatively large and therefore have a major influence on the properties of the sample. Due to the size of the markers alone, the method is not suitable for separately observing two objects that are only a few nanometers apart in order to track their movements.

In the state of the art, camera-based localization microscopy methods of fluorescence microscopy are known, which enable fluorescence imaging with high spatial resolution in the range of usually a few tens of nanometers in several colors, i.e. using fluorophores that have very different excitation spectra or different emission spectra or both. The spatio-temporal resolution of these methods is limited by the camera and the brightness of the emitters, so that they are at best suitable for observing slow movements. Suitable emitters are in particular functionalized core-shell quantum dots, which are very photostable and very bright, but have so far rarely been used in fluorescence microscopy. One such method is described in the publication “Differential Labeling of Myosin V Heads with Quantum Dots Allows Direct Visualization of Hand-Over-Hand Processivity” (Warshaw DM et al., Biophys J. 2005 May; 88(5):L30-2. doi:10.1529/biophysj.105.061903. Epub 2005 Mar. 11. PMID: 15764654; PMCID: PMC1305523.). A spatial resolution of 6 nm with a temporal resolution of 83 ms is achieved. In order to observe the movement of dual-stained motor proteins and thus the movement of the ends of the motor proteins separately, a very low ATP concentration was set in the sample. Similar studies using fluorophores more commonly used in fluorescence microscopy, namely Cy3 and Cy5, using two excitation wavelengths with TIRF illumination minimizing background fluorescence are described in the publication “Single molecule high-resolution colocalization of Cy3 and Cy5 attached to macromolecules measures intramolecular distances through time” (L. Stirling Churchman et al., Proc Natl Acad Sci USA. 2005 Feb. 1; 102(5):1419-23. Doi: 10.1073/pnas.0409487102. Epub 2005 Jan. 24. PMID: 15668396; PMCID: PMC545495.). Here, a lateral resolution of about 6 nm is achieved with an integration time of 0.5 s.

A multicolor scanning microscope or a corresponding method that allows fluorescence imaging with high spatial resolution in the range of a few nanometers is known from the publication “Ultrahigh-resolution multicolor colocalization of single fluorescent probes” (Thilo D. Lacoste et al., Proc Natl Acad Sci USA. 2000 Aug. 15; 97(17):9461-6. Doi: 10.1073/pnas.170286097. PMID: 10931959; PMCID: PMC16886.). Here, different fluorophores are used, which are all excited with the same wavelength, as the precision of the superposition of the excitation light beams required for the resolution to be achieved when using several excitation wavelengths is not possible. The sample is scanned confocally, the fluorescent light is spectrally split into two or more channels and a multi-color image is generated from the measured values. The method is used to determine distances between fluorophores of different colors in the range of approximately 10 nm. This method is just as unsuitable for fast simultaneous and separate tracking of several emitters as the camera-based localization microscopy methods mentioned here.

In the publication “Nanometer resolution imaging and tracking of fluorescent molecules with minimal photon fluxes” (Balzarotti, F. et al., Science. 2017 Feb. 10; 355(6325):606-612. doi: 10.1126/science.aak9913. Epub 2016 Dec. 22. PMID: 28008086), a method for localizing and tracking individual emitters is presented and referred to as MINFLUX. According to this method, the emitter is illuminated with focused excitation light with an intensity distribution that has a central local intensity minimum, in particular a zero point, with adjacent intensity increase regions, the center of which is placed in a temporal sequence at different positions in a close range around an assumed position of the emitter in such a way that the emitter is located in each case within the intensity increase regions surrounding the minimum, wherein the fluorescence emission is measured and assigned to the respective position of the center and wherein the position of the emitter is determined from the positions and the assigned photon numbers or fluorescence intensities. A method for estimating the position of an emitter in real time is given for tracking an emitter in real time over a range which requires that the intensity distribution is tracked to the particle in order to achieve that its center is located in a temporal sequence in each case at different positions in a close range around an assumed position of the emitter such that the emitter whose movement is tracked is located in each case within the intensity increase regions delimiting the minimum. An essential feature of the MINFLUX methods described in the publication is that a local minimum of an excitation light distribution is placed close to the position of an emitter so that the emitter is located within the intensity increase regions adjacent to the minimum. The outlook indicates on the one hand that the illumination positions can be illuminated with varying intensity distributions, and on the other hand that the method could also be further developed in the future for use in multi-color images. In this context, the distinction between emission spectra, polarization or fluorescence lifetime is pointed out. Corresponding concrete solutions are not specified.

In Jasmin Pape's dissertation, “Multicolor 3D MINFLUX nanoscopy for biological imaging” (Göttingen, 2020, http://dx.doi.org/10.53846/goediss-8248), the theoretical background to the application of the MINFLUX method for the simultaneous tracking of emitters of different colors is described on the one hand and, on the other hand, an initial experimental proof of concept is described, but this only relates to immobilized emitters and therefore not to the actual simultaneous tracking of two emitters. The theoretical considerations refer to a situation in which emitters with different spectral emission distributions are located together in a scanned close range and in which the fluorescence emission is detected in several spectral channels. The spectral separation can be complete or incomplete, i.e. the influence of cross-talk is addressed. The explanations of the theory refer to the information content that is in principle contained in the correspondingly recorded data. It is stated that a position estimate using a maximum likelihood estimator (MLE) has a bias, i.e. a systematic error, which is particularly relevant for small numbers of photons. It is pointed out analogously that the information about the position of the emitters cannot be extracted in a simple way as in the determination of the position of only one emitter, because, at least in the case of non-vanishing cross-talk, the determinations of the positions of the emitters cannot be carried out independently of each other. In particular, it is stated that in order to obtain a high time resolution when tracking multiple emitters, it is necessary to develop a position estimator that has no bias. Such a position estimator actually suitable for the simultaneous tracking of two fluorophores with different spectral emission is not specified in the dissertation. Accordingly, the proof of feasibility with regard to the simultaneous tracking of two emitters is an experimental determination of the positions of two immobilized emitters in each case as part of a subsequent detailed analysis of data sets recorded within stationary close ranges.

In the above-mentioned dissertation and in the publication “Multicolor 3D MINFLUX nanoscopy of mitochondrial MICOS proteins” (Pape et al., Proceedings of the National Academy of Sciences of the USA, 117(34), 20607-20614. (2020), doi:10.1073/pnas.2009364117), imaging of a sample stained with two different dyes using MINFLUX is described. Here, individual emitters are localized once or several times in total, the localizations are assigned to one of the dyes and different localizations of one and the same emitter are assigned to each other in a cluster analysis.

In the publication “MINFLUX nanoscopy delivers 3D multicolor nanometer resolution in cells” (Gwosch et al., Nat Methods 17, 217-224 (2020). https://doi.org/10.1038/s41592-019-0688-0), imaging of a sample stained with two different dyes using MINFLUX is also described. For imaging, fluorophores are used that can be excited using a common excitation wavelength and have measurably different spectral emission spectra. The fluorophores are activated individually with activation light immediately before they are localized. The MINFLUX measurements are now carried out in such a way that the fluorescence emission is spectrally split using a dichroic beam splitter and the fluorescence emission is detected separately in each of the two spectral channels. Emitters are localized on the basis of the sum signal, using a modified least mean square estimator (mLMSE) (see in the publication cited above “Nanometer resolution imaging and tracking of fluorescent molecules with minimal photon fluxes”) as an estimator. This estimator is used to estimate the position of a single fluorophore. As part of a subsequent data analysis, which includes an initial assignment based on the number of photons detected in the individual channels and then a principal component analysis to refine the assignment, the localizations are assigned to individual dyes. This type of image acquisition is referred to as “simultaneous two-color registration” in the introductory section of the publication. Looking ahead, it is proposed, among other things, to reduce the measurement time by localizing several molecules as part of a localization procedure, although no further details are given.

The international patent application disclosure WO 2021/122407 A1 discloses a method for improving localizations according to a MINFLUX method by detecting and taking into account disturbances occurring during the measurement. A corresponding microscope is described. The method is intended on the one hand to determine a trajectory of a fluorescent dye molecule, i.e. to track a molecule, and on the other hand to determine the locations of several different dye molecules. A microscope has two excitation lasers of different wavelengths. The light paths of both lasers pass together through a deflection device with two electro-optical deflectors (EOD), are then separated, and a liquid crystal modulator (spatial light modulator, SLM) is located in each individual path in order to form a light distribution in the excitation focus with a local intensity minimum in the sample after focusing through an objective in the common beam path. In addition to other components, the microscope contains a beam splitter for splitting the fluorescent light into two spectrally separated detection channels corresponding to the emission ranges of two different dyes. With regard to imaging in several colors, reference is made on the one hand to techniques known from PALM and STORM microscopy, and on the other hand it is mentioned that with the aid of appropriate illumination and detection means, if fluorescent dye molecules are present at a distance greater than the diffraction limit, simultaneous or quasi-simultaneous location determination of several fluorescent dye molecules is also possible. No further details are given in this regard. A simultaneous determination of the location of several fluorophores that are separated by less than the diffraction limit is not disclosed.

In the international patent application disclosure WO 2022/136361 A1 , a method is described in which the tracking of particles is restricted to those areas in the sample in which relevant information about the sample is obtained from the tracking of the particles. To make this possible, a second measurand, which can also be a fluorescence intensity, is recorded in the sample. The tracking of a particle in question is then interrupted or terminated when a control value determined from the second measurand fulfills a termination criterion.

The international patent application disclosure WO 2021/239679 A1 describes a method for the simultaneous localization of several fluorophores and for the simultaneous tracking of the movements of several fluorophores according to a MINFLUX method and a device designed for carrying out the method. The fluorophores to be localized have distances between them that are significantly greater than the diffraction limit. In connection with information on a camera for detecting the fluorescent light, it is pointed out that the use of several wavelengths can also be considered. No further details are provided in this regard.

The international patent application disclosure WO 2022/079265 A1 describes methods, in particular MINFLUX methods and MINFLUX-like methods, in which a displacement of an intensity distribution of a fluorescence-inhibiting light with a central minimum takes the place of the displacement of a corresponding excitation light, for the localization microscopic examination of a sample stained with several dyes, and a microscope set up for carrying out one of the methods. All methods are aimed at placing a nanoscopic image in the spatial context of microscopic images or performing nanoscopic tracking of individual molecules in the spatial context of a microscopic image. For this purpose, methods are proposed in which several detection channels, possibly sequentially, and in many cases also several excitation wavelengths are used. Certain methods should enable an optimized ratiometric separation of the dyes, for example as described in the above-mentioned publication “MINFLUX nanoscopy delivers 3D multicolor nanometer resolution in cells”. Simultaneous localization or tracking of multiple fluorophores is not described.

In the publication “Two-photon MINFLUX with doubled localization precision” (Zhao, K. et al., eLight 2, 5(2022). https://doi.org/10.1186/s43593-021-00011-x), the theory of localization according to the MINFLUX method using two-photon excitation is described. It is pointed out that there are different fluorophores that can be excited with one and the same excitation wavelength using two-photon processes and that have easily completely separable emission spectra. This enables, among other things, the simultaneous tracking of several fluorophores, which is essential for the investigation of molecular interactions, for example protein-protein interactions, protein-nucleic acid interactions or virus-cell interactions.

Patent application disclosure US 2022/163440 A1 describes methods and devices for nanoscopic examination based on the observation of individual molecules in, particularly biological, samples. When carrying out the examination, a target is held in the region of a local zero point of a focused intensity distribution by moving the sample relative to this intensity distribution in such a way that movement of the target in the sample is compensated for. A temporal resolution of around 10 ms is specified as more than sufficient for compensation. At the same time, the movement of the target in the sample is tracked in this way. In several embodiments, the intensity distribution at the zero of which the target is held is that of a fluorescence inhibiting light. In other embodiments, it is an intensity distribution of a tracking beam of a wavelength of 488 nm, which is used for localization of the target using MINFLUX. This localization can be done with a higher temporal resolution than the one mentioned above, so that the movement of the target can also be tracked in this higher temporal resolution. Even in cases where the target is held in the area of a local zero of a focused intensity distribution of fluorescence-inhibiting light, the localization, on the basis of which the compensation of the movement takes place, can be carried out using MINFLUX. In cases where localization is performed using MINFLUX, this localization is now used either to keep the target in the area of a local zero point of a focused intensity distribution of fluorescence inhibition light or in the area of a local zero point of the tracking beam as well as in the area of a central maximum of an intensity distribution of excitation light. On the one hand, the target is now tracked and, on the other hand, further single-molecule events are detected in the vicinity of the target using excitation light of several wavelengths, so that, for example, the time sequence in which various fluorescent samples (fluorescence-labeled bio-molecules) attach to the target is detected. The tracking beam itself can be moved quickly using electro-optical deflectors, while the other intensity distributions are moved much more slowly in relation to the sample using a nanopositioning stage. The movement of two fluorophores against each other is not observed with this method.

In the publication “MINFLUX nanometer-scale 3D imaging and microsecond-range tracking on a common fluorescence microscope” (Schmidt, R. et al., Nat Commun 12, 1478(2021 ). https://doi.org/10.1038/s41467-021-21652-z), a MINFLUX method for tracking fast movements with a temporal resolution of about 100 us at a spatial resolution of better than 20 nm is described on the one hand, and 3D MINFLUX imaging with resolutions in the range of a few nanometers is described on the other hand, both in one color. Both the tracking of particles and the 3D MINFLUX images are carried out with a commercially available microscope. The high resolution is made possible on the one hand by active stabilization of the sample. On the other hand, a correction with regard to the background is already applied during data acquisition, which optimizes the estimation of the respective position of the fluorophores in real time and thus the data acquisition as a whole. The excitation of a fluorophore for its MINFLUX localization is carried out using a cw laser with a wavelength of 642 nm.

In the publication “MINFLUX dissects the unimpeded walking of kinesin-1” (Wolff, Jan O. et al., bioRxiv 2022.07.25.501426; doi: https://doi.org/10.1101/2022.07.25.501426) the tracking of motor proteins with high spatiotemporal resolution using MINFLUX is described. In one variant, motor proteins are each labeled with a fluorophore at two binding sites, whereby the two fluorophores are identical. Both fluorophores are tracked simultaneously using a pair of excitation light distributions, one of which has a minimum extended in a y-direction in the illumination focus and the other of which has a minimum extended in an x-direction. The distributions are used iteratively to determine a fluorophore position, whereby a new position of the fluorophore is estimated in each case from fluorescence measurement values and assigned courses of intensity increase regions. At least two intensity distributions are used for each position determination in one spatial direction. Each of these intensity distributions has a minimum and intensity increase areas adjacent to the minimum on both sides; the intensity distributions differ from each other in terms of their shape. In a zero position, the intensity distributions are symmetrical to a central intensity minimum. In a position deviating from the zero position, the central minimum is shifted and the symmetry of the intensity distribution is disturbed, so that the intensity distributions used differ not only in terms of the position of the local intensity minimum, but also in terms of their shape. When estimating the position, the position of the center point between the two fluorophores is inherently retained.

According to patent specifications EP 2 780 694 B1 and U.S. Pat. No. 9,291,562 B2, the movement of a particle in the sample is to be tracked by detecting light emitted from the region of a spatially limited minimum of an excitation intensity distribution and by shifting the excitation intensity distribution in the sample in each case, for example by means of a beam scanner, in such a way that the rate of photons emitted by the particle remains minimal. According to the patent specifications, it should be possible to track two particles quasi-simultaneously by carrying out the process alternately for each particle individually. It should also be possible to track several particles simultaneously, provided that several beam shaping means and several beam deflection means are available. Beam sources of different wavelengths could also be used for simultaneous tracking. As a solution to ensure that the rate of photons emitted by the particle remains minimal, it is proposed to shift the intensity distribution experimentally each time the rate has increased due to movement of the particle. The particle could be tracked in this way because a minimum rate would only be achieved when the intensity distribution has been shifted in the direction of the movement of the particle. Alternatively, it would also be possible to observe the movement by means of a camera and to track the beam according to the movement determined in this way until the rate of the photons, i.e. the measured brightness assigned to the particle in the camera image, is minimal.

This method has the fundamental disadvantage that it is hardly possible to track fast-moving fluorescent particles with high spatial resolution. If the rate of the photons is to be kept to a minimum by experimentally shifting the intensity distribution, this experimental shift, during which the rate of the photons is to be determined in such a way that the position at which it is minimal is recognized, must be carried out at a speed that is high compared to the speed of movement of the particle. This precludes fast-moving particles from being reliably tracked with high spatial resolution. If two particles located at a distance of less than the diffraction limit are to be tracked simultaneously or quasi-simultaneously, the additional problem arises that the rates of the photons for the two particles can only be kept to a minimum independently of each other if crosstalk between the fluorescence of one fluorophore and the detection channel of the other fluorophore is completely excluded, i.e. not just approximately.

### Objective

It is now a objective of the present disclosure to provide solutions that enable simultaneous tracking of two optically distinguishable light-emitting particles or light-emitting units that are closely adjacent with high spatial and temporal resolution.

### Solution

This problem is solved by a method according to claim 1 and by a device according to claim 24. Advantageous embodiments of the method according to the present disclosure are given in subclaims 2 to 23, and an advantageous embodiment of the device according to the present disclosure is given in claim 25. These and further advantageous embodiments are described below.

### DEFINITIONS

In this application, emitters are understood to be objects which, when illuminated with excitation light, can be regarded as point light sources with regard to the measurements according to the present disclosure. The light emitted by the object acting as a point source can, for example, be scattered light resulting from elastic scattering such as Rayleigh scattering or inelastic scattering such as Raman scattering, or it can be luminescent light, in particular fluorescent light. It is essential for an emitter that it emits light immediately or with a short time delay in response to illumination. The maximum time delay is related to the temporal resolution with which the movements of the light-emitting particles or light-emitting units are to be tracked and to the speed at which the particles or units move in the sample. The time delays can be up to about 10 μs, but are usually in the range up to a few tens of nanoseconds, often in the range of 1 to 10 ns and, if the emission is scattered light, zero. In this application, the term fluorescence emitter is used to designate emitters that act as fluorescence point light sources. Emitters can be, for example, metallic nanoparticles. The more specific term fluorescence emitter includes, for example, individual fluorescent dye molecules or their fluorescent chemical groups. Such emitters and in particular such dyes can couple to biomolecules, which they then label. It is also possible for several scattering emitters or dye molecules to couple to a structure to be labeled, for example to a biomolecule or a biological microstructure. In this case, two cases must be distinguished. If several optically indistinguishable or indistinguishable emitters, such as several identical dye molecules, bind to the structure in the immediate vicinity, for example within 1 nm or a few nanometers of each other, they can be considered together as one emitter. The same applies if a small structure with several indistinguishable emitters, for example with identical fluorophores, is coupled to a target structure to be labeled. In the other case, optically distinguishable emitters such as different dyes are used to label different areas of a structure, for example a biomolecule such as a motor protein. The different areas can have very small distances to each other in the range of a few nanometers, whereby the expansion of the individual emitters should be smaller than these distances. Here, too, several fluorophores, i.e. fluorescent molecules or fluorescent groups of molecules, can form a fluorescent unit at each of the points of the structure to be distinguished and thus together form an emitter or several scattering objects together form a scattering emitter. Instead of dyes, other fluorescent units such as quantum dots (see below state of the art: “Differential Labeling of Myosin V Heads with Quantum Dots Allows Direct Visualization of Hand-Over-Hand Processivity”) or up-converting nanoparticles can also be used for labeling.

Accordingly, in the context of the application, excitation light is understood to mean not only fluorescence excitation light, but generally such light that causes light to emanate from an emitter.

In this application, STED light is understood to mean light that suppresses fluorescence emission by exciting stimulated emission, as is common practice. In the context of this application, STED light is a special form of emission suppression light.

In this application, MINFLUX methods are understood to mean methods for the localization of emitters, whereby intensity distributions of an excitation light in a sample with a minimum and intensity increase regions adjacent to the minimum are used several times, whereby the location of the emitter is inferred from several different courses of intensity increase regions over an emitter and measured values of the emission assigned to the courses. Different profiles of intensity increase regions adjacent to the minimum over an emitter can be obtained, for example, by placing the minimum of a certain intensity distribution at different positions such that the emitter is located at different positions relative to the minimum within an intensity increase region. Different courses of intensity increase regions can also be obtained by placing different intensity distributions with a minimum and intensity increase regions adjacent to the minimum in the sample so that the emitter is located in an intensity increase region in each case. Different courses of intensity increase regions can also be obtained by combining both measures, placing the minimum at different positions and using several different intensity distributions.

Methods for localizing emitters using a local minimum of an intensity distribution of an excitation light, whereby the location of the emitter is deduced from several positions of the local minimum and the measured emission values assigned to the positions, are therefore MINFLUX methods. The intensity distributions between the positions at which the minimum is positioned can differ from one another. The phrase “using a local minimum” means that the minimum in each dimension in which the location of the emitter is to be determined is positioned at several such positions for which the condition is met that the emitter is located in an intensity increase region adjacent to the local minimum. There, it is not ruled out that the minimum is also placed at positions for which the above-mentioned condition is not fulfilled.

In this application, STED-MINFLUX methods are understood to be methods corresponding to MINFLUX methods as defined above, with the deviation that the intensity distribution of excitation light is replaced by an intensity distribution of emission suppression light that overlaps with excitation light.

That the intensity distribution of emission suppression light overlaps with excitation light means that excitation light is applied to the sample in the region of the intensity minimum and the adjacent portions of the intensity increase regions of the emission suppression light, within which an emitter is located, such that an emission of the emitter is excited or would be excited in the absence of emission suppression light, so that the emission suppression light affects the excited emission or the excitation of the emission according to its intensity distribution in such a way that a measured emission of an emitter located within the intensity distribution of the emission suppression light decreases with increasing distance from the intensity minimum. If the emission suppression light is STED light and the emitter is a fluorescence emitter, this means that the spontaneous emission of the fluorescence emitter decreases with increasing distance from the intensity minimum of the STED light. The stimulated emission of the emitter, which has the same wavelength as the STED light, does not contribute to the measured emission, as is usual in STED microscopy; it is blocked by a filter, for example. The fact that the intensity distribution of emission suppression light overlaps with excitation light does not mean that the excitation light and the emission suppression light are introduced into the sample strictly simultaneously. For example, as is common in STED microscopy, it is possible to use a short pulse of excitation light immediately followed by a pulse of STED light as emission suppression light. The excitation light with which the intensity distribution of emission suppression light overlaps can, for example, have an intensity distribution as is usual in confocal microscopy, i.e. at least approximately correspond to an Airy function or a Gaussian function, whereby the central maximum of it can coincide with the minimum of the emission suppression light. It can also correspond to a top-hat function. Constant excitation in the wide field is also possible.

The term STED-MINFLUX is used in a generalized sense and should in no way be understood to mean that the emission suppression light must be STED light

The fact that two emitters are closely adjacent means that the emitters are at a distance from one another at which, when a MINFLUX method is carried out on one of the emitters, the other of the emitters necessarily comes into the area of influence of the excitation light or, when a STED-MINFLUX method is carried out on one of the emitters, the other of the emitters necessarily comes into the area of influence of the emission suppression light, so that, when both emitters are localized simultaneously, the localizations cannot be regarded as independent of one another on the basis of the distance. In particular, two emitters are closely adjacent if their distance to each other is smaller than a distance between the nearest neighboring zeros of an Airy function corresponding to the largest wavelength of the light used when performing the method and the numerical aperture of the focusing, referred to as less than one Airy diameter for short. If the distance in these cases is less than half an Airy diameter, the emitters are also referred to as very closely adjacent. In cases in which the intensity distributions are generated without focusing optics, emitters with a distance smaller than the longest wavelength of the light used are particularly closely adjacent. In such a case, if the distance between the emitters is less than half of the longest wavelength used, the emitters are also referred to as very closely adjacent.

In the context of the application, emitters in which it is possible to assign emissions to one or the other emitter even if both emitters are in the immediate vicinity of each other are referred to as optically distinguishable emitters. The possibility of assignment can be based on different optical properties, for example with regard to the excitability of emissions, or alternatively or additionally on different properties of the emissions of the emitters. It is not necessary for the assignment to be completely certain. Individual emitters whose emissions could not be assigned to a specific emitter if the two emitters were in the immediate vicinity of each other are therefore referred to as not optically distinguishable from each other.

In the context of the application, an emitter is designated as isolated if a distance to a nearest neighboring emitter, from which it cannot be distinguished optically, is at least as great as a distance corresponding to the resolution of the optical arrangement with which the emissions are detected when the method is carried out.

In this application, a 3D minimum is understood to be a minimum that is surrounded by intensity increase regions in all spatial directions. A 3D minimum can be obtained, for example, by superimposing two light beams, whereby the wavefront of one of the two is modulated in phase in a pupil by means of a so-called annular phase plate and that of the other by means of a vortex phase plate.

In this application, a 2D minimum is understood to be a minimum that is surrounded by intensity increase regions in all spatial directions within a given plane and extends along an axis perpendicular to this plane. A 2D minimum can be obtained, for example, by means of a vortex phase plate in the beam path. The minimum extends, for example, along the optical axis of an objective, while it is surrounded by intensity increase regions in directions perpendicular to the optical axis. In principle, however, the plane within which the intensity increase areas extend can also have a different orientation in space In this application, a 1D minimum is understood to be a minimum which is surrounded by intensity increase regions in a spatial direction perpendicular to a given plane. Such a minimum can be generated, for example, by means of a phase retardation plate which, in particular in a pupil, delays one half of a wavefront relative to the other half of the wavefront by λ/2, with the bisection of the wavefront taking place along a straight line. An alternative method for generating 1D minima, which is mentioned here as a further example, is described in the publication “MINFLUX dissects the unimpeded walking of kinesin-1” (Wolff et al.), which is cited as state of the art.

### Description

The present disclosure relates to a method for simultaneously tracking the movement of a first emitter and a second emitter, optically distinguishable from the first, which are closely adjacent, in a sample by means of a MINFLUX method or a STED-MINFLUX method.

According to the present disclosure, an illumination and measurement step is carried out in which the sample is illuminated with intensity distributions of excitation light or of emission suppression light, in particular of STED light, overlapping with excitation light, which have a local minimum and intensity increase regions adjacent to the minimum in a measurement area, wherein different courses of intensity increase regions of a predetermined set of courses of intensity increase regions in an assumed location range of at least the first emitter are generated in a temporal sequence. Furthermore, in the illumination and measurement step, emissions of the first emitter and optionally of the second emitter are measured and measured values of the emission are assigned to the respective courses of intensity increase regions.

Furthermore, according to the present disclosure, a location determination step is carried out. In this step, a location of the first emitter is determined on the basis of the different courses of intensity increase regions and the associated measured values of the emission, or locations of the first and of the second emitter are determined, or a common mean location of both emitters is determined.

Such a method, in which the locations of two closely adjacent emitters, specifically two fluorophores, are determined, is known in principle from the dissertation by Jasmin Pape, which was discussed in the section on the state of the art. However, with regard to the simultaneous measurement of several fluorophores, only data on stationary objects are shown in the dissertation. The locations are determined as part of an evaluation after the measurements have been completed.

In contrast, in the context of the present disclosure, the location determination step already takes place during the duration of the data recording, which makes it possible to track mobile emitters over distances that are greater than an extension of the area recorded during an illumination and measurement step. On the basis of either the location of the first emitter determined in the location determination step or the locations of both emitters determined in the location determination step or the common mean location of both emitters determined in the location determination step, a respective new assumed location range and in total a new set of courses is determined for each of the emitters according to the present disclosure. Furthermore, according to the present disclosure, the illumination and measurement step and the location determination step are repeated using the new set of courses.

According to one embodiment, the excitation light comprises first excitation light for exciting the first emitter and second excitation light for exciting the second emitter, that is, both emitters are excited by excitation light according to the present disclosure. This applies both in the case where the excitation light in the measuring area forms the intensity distribution having the local minimum and in the case where an emission suppression light in the measuring area forms the intensity distribution having the local minimum and the excitation light overlaps with this intensity distribution. In principle, the first excitation light can be identical to the second excitation light. This has the advantage that no spatial deviations dependent on the excitation can occur. This advantage can be particularly relevant if the excitation light forms the intensity distribution with the local minimum, especially as a focused intensity distribution. If, on the other hand, the first and second excitation lights are not identical, in particular the first and second excitation lights may be guided in a common beam path or, for example, both excitation lights may be guided in a section in a common fiber. The purpose of these measures is to ensure that the intensity distributions of both excitation lights in the sample are optimally adjusted to each other. The beam paths can particularly be “aligned by design”—this term is commonly used in connection with STED microscopy with regard to adjusting the STED light to the excitation light

That the movements of a first and a second emitter which are closely adjacent in a sample are tracked by means of a MINFLUX method or a STED-MINFLUX method does not mean that a MINFLUX or a STED-MINFLUX method must be performed for each of the emitters according to the definitions given above. Rather, only a MINFLUX or a STED-MINFLUX procedure must be performed at all with respect to at least one of the emitters and the movements of both emitters must be tracked by means of the procedure. Preferably, a MINFLUX or a STED-MINFLUX method is carried out at least with reference to the first emitter.

The fact that the movements of closely adjacent emitters are tracked does not preclude the same emitters not being closely adjacent before or after the movements are tracked by means of the method according to the present disclosure, but their movements are nevertheless tracked simultaneously. Nor does it preclude that, before or after tracking the movements by means of the method according to the present disclosure, only the movement of one of the two emitters is tracked until it has come close to the other or after it has moved away from the other.

In particular embodiments, the first and second excitation lights are different in terms of their spectral composition. The use of excitation lights that differ from each other is a means of achieving optical separation of the two emitters from each other. For example, the first excitation light may comprise a first spectral range and the second excitation light may comprise a second spectral range which is different from the first spectral range, in particular not overlapping with the first spectral range. Both the first excitation light and the second excitation light can in particular be narrow-band light, in particular laser light, for example with a bandwidth smaller than 10 nm or smaller than 5 nm or smaller than 1 nm or smaller than 0.1 nm; both the first excitation light and the second excitation light can be narrow-band or monochromatic laser light. In particular embodiments, a spacing of the spectral regions or the wavelengths may be more than 50 nm, more than 100 nm, more than 150 nm or more than 200 nm. The use of spectrally different excitation lights enables, for example, the use of emitters such as fluorophores with strongly differing excitation spectra. This in turn enables largely separate excitation of the first and second emitters, in particular a first and a second fluorescence emitter, i.e. excitation with low cross-excitation, or even completely separate excitation of one of the emitters. Cross-excitation is understood here to mean that one excitation light not only excites the associated emitter, as desired, but also the other emitter. Cross-excitation can be described as low if the undesired excitation is small in relation to the desired excitation. In particular, the spectral compositions of the first excitation light and the second excitation light and the first and second emitters are therefore matched to each other in such a way that excitation of the second emitter by the first excitation light is minimal in relation to excitation of the first emitter by the first excitation light or, with the same excitation intensity, is at most 10%, particularly at most 5%, more particularly at most 1%, still more particularly at most 0.1% of the excitation of the first emitter, and/or that correspondingly an excitation of the first emitter by the second excitation light is minimal or, with the same excitation intensity, is in particular at most 5%, particularly at most 1%, still more particularly at most 0.1% of the excitation of the second emitter. In particular embodiments, the spectral compositions of the first excitation light and the second excitation light and the first and second emitters can therefore be matched to each other in such a way that the cross-excitation of the first emitter by the second excitation light is particularly low, while accepting that the cross-excitation of the second emitter by the first excitation light is higher. This applies in particular to such embodiments in which a location of the first emitter is determined in the location determination step and, on the basis of the location of the first emitter determined in the location determination step, a respective new assumed location range for each of the emitters and overall a new set of courses is determined .. A respective assumed location range can therefore be determined on the basis of the location of the first emitter determined in the location determination step, because it can be assumed that the emitters are closely adjacent in the sense defined in this application. The close proximity may be due to the fact that both emitters are coupled to the same biological structure, for example to a motor protein. Knowledge of the position of the first emitter thus results in knowledge of the position of the second emitter, albeit usually less precise knowledge.

In embodiments in which the first and second excitation light are different in terms of their spectral composition, the illumination with the first excitation light and the illumination with the second excitation light can be carried out separated from each other in time in the illumination and measurement step. This can be carried out either in such a way that during an illumination and measurement step, all measurement data for the first, or alternatively the second, excitation light are first recorded and then all measurement data for the second, or alternatively the first, excitation light are recorded, or in such a way that the first and second excitation light are used alternately, for example “pulse interleaved”, in such a way that all associated measurement data are recorded virtually simultaneously. In conjunction with the difference in the spectral compositions of the excitation lights, the measured values of the fluorescence emission, which are each recorded in an illumination and measurement step, can be assigned not only to the position at which the illumination light is positioned or the respective course of the intensity increase region generated in the sample, but also to the emitter from which the emission originates. Such a temporal separation can be achieved, for example, by means of optical switches, such as acousto-optical modulators. These switches can, for example, switch which of several light sources is coupled into the optical path to illuminate the measurement area in the sample, or they can block out light within an optical path or decouple it from the path.

In principle, the method according to the present disclosure can be carried out using temporally continuous light sources or one temporally continuous light source, for example using one or more cw lasers. As explained above, this also applies to embodiments in which the illumination with the first excitation light and the illumination with the second excitation light are performed separately in time. It also applies regardless of whether the excitation light forms the intensity distribution that has the minimum in the measuring area or whether the excitation light overlaps with the intensity distribution that has the minimum in the measuring area. In this case, each of the lights can also be a temporally continuous light.

In particular embodiments, the excitation light can be pulsed. This results in various advantages. For example, if two or more excitation lights are used, the illumination with the first and with the second and/or also with further excitation light can take place alternately, whereby a pulse of one excitation light can then be followed by a pulse of the other excitation light. This does not exclude the possibility of one or more further pulses, for example a pulse of emission suppression light, occurring between two pulses following each other in this way. Switching between the excitation lights can take place quickly, for example if two light sources are operated with the same pulse frequency, with twice the pulse frequency of the two lasers. For example, pulsed lasers, such as diode lasers or fiber-amplified diode lasers with pulse frequencies of 80 MHz, are available and suitable for carrying out embodiments of the method according to the present disclosure. If two such light sources are now used, the illumination can be pulsed at a total frequency of 160 MHz, with each individual excitation light being irradiated into the sample at a frequency of 80 MHz. A time interval between individual pulses in this case is 6.25 ns and is therefore very small in relation to the time scales of the movements that are typically to be tracked using the method according to the present disclosure, so that the illumination with the various excitation lights is quasi-simultaneous in relation to the processes to be observed. This also applies in many cases when pulsed light sources with lower pulse frequencies such as 60 MHz or 40 MHz are used. Applicable pulsed light sources can also be light-emitting diodes, for example. Further advantages are discussed elsewhere. The above statements apply regardless of whether the excitation light forms the intensity distribution that has the minimum in the measuring area or whether the excitation light overlaps with the intensity distribution that has the minimum in the measuring area.

The pulse durations of the pulsed excitation light can be matched to the photophysical properties of the emitters used to mark structures in the sample. For example, with regard to photobleaching of emitters, especially fluorescent emitters, it may be favorable to use longer pulses with durations in the range of a few nanoseconds. In other cases, for example with a view to determining emission lifetimes such as fluorescence lifetimes or with a view to assigning measured values of the emission not only to the position at which the illumination light is positioned or the course of the intensity increase region generated in the sample, but also to the emitter from which the emission emanates, it is favorable to use pulses with pulse durations in each case shorter than the expected emission lifetimes of the emitters concerned. Typical fluorescence lifetimes are generally in the range from about 1 ns to about 100 ns. Pulse durations of the excitation light to be used in the context of methods according to the present disclosure may be a few nanoseconds or less, for example 3 ns, particularly less than 1 ns, more particularly less than 300 ps, more particularly less than 150 ps and even more particularly less than 100 ps. The provision of a pulsed light source in the device according to the present disclosure, which is set up to emit pulses with durations of less than 1 ns or 150 ps, has the advantage that excitation with light pulses, which is short in comparison with the fluorescence lifetime, is available for all samples labeled with fluorescence emitters, irrespective of the specific fluorescence emitters present. The above statements apply regardless of whether the excitation light forms the intensity distribution that has the minimum in the measuring area or whether the excitation light overlaps with the intensity distribution that has the minimum in the measuring area.

If the intensity distribution showing the minimum is an intensity distribution of emission suppression light that overlaps with excitation light, then the emission suppression light can be either continuous light or pulsed light. The same applies, as already mentioned above, to the excitation light to be used in this case, whose distribution in the measuring area overlaps with the distribution of the emission suppression light. In this case, however, the excitation light is in particular pulsed light. Further, in said case the emission suppression light is in particular pulsed light, and in said case both the excitation light and the emission suppression light are in particular pulsed light. In the case that the emitters used are fluorescence emitters or in particular fluorophores, the emission suppression light is particularly STED light, in particular pulsed STED light.

The emission is particularly measured using one or more detectors that are set up to detect individual photons and thus count photons. Such detectors include so-called photomultiplier tubes (PMT), avalanche photodiodes (APD) and hybrid photodetectors (HPD). It is particularly advantageous that the emission is measured by means of arrays of such detectors, whereby it is advantageous that apertures of such arrays are arranged in an image plane in such a way that the distances between neighboring apertures in the plane are smaller than the diffraction limit of the image in the image plane, particularly smaller than half of the diffraction limit, more particularly smaller than a quarter of the diffraction limit. Such an arrangement can be achieved, for example, with an APD array with appropriately dimensioned individual elements or by arranging fiber ends of a fiber bundle, the individual fibers of which are each guided to an individual detector, for example a PMT, in the image plane.

If the excitation in the illumination and measurement step is pulsed, the emission excited by the respective pulse is particularly measured with time resolution, particularly with a time resolution better than 1 ns, more particularly better than 100 ps, even more particularly better than 30 ps. A time-resolved measurement in this way can be used, for example, to record the temporal course of the emission and, in the case of fluorescent emitters, to determine the fluorescence lifetimes from the measurements. The time-resolved measurement has particular advantages in conjunction with a determination of the trajectories of the first and second emitters as part of a subsequent data analysis, i.e. in an evaluation step, after the tracking of the movement of the first and second emitters has ended.

The temporal resolution of the measurement can also be used to generally improve the optical separation of the two emitters from each other, for example in particular to improve an assignment of measured values of the emission to the emitter from which the emission emanates during the data acquisition and/or after a termination of the tracking of the movement of the first and the second emitter. In particular when performing an evaluation step after completion of the data acquisition, in which on the basis of the measured emission values obtained in the repeatedly performed illumination and measurement steps and the associated respective trajectories generated during the data acquisition, trajectories of the first and second emitters are determined, different fluorescence lifetimes may also be the sole or the essential criterion on the basis of which optically distinguishable emitters are actually separated, that is, on the basis of which an emission, in particular a detected photon, is assigned to the first but not to the second emitter or to the second but not to the first emitter.

As an alternative or in addition to a high-resolution temporal measurement of the emission, gated detection can also be used. This can be used to detect emission as a function of time.

As already explained, it is crucial for carrying out the methods according to the present disclosure that a differentiation of the emitters, i.e. an optical separation of the emitters, takes place. In embodiments in which the locations of the first and second emitters are determined in the respective location determination step, this optical separation already takes place during data recording; in other embodiments, it is possible that this optical separation does not already take place during data recording, but only after the end of tracking of the first emitters and the second emitter. Even if locations of the first and second emitters are determined in the location determination step, this optical separation does not have to be complete, i.e. errors in the assignment of measured values of the emission to the emitter from which the emission originates can be tolerated to a certain extent. It may also be the case that an emission is assigned to the first emitter during data acquisition, but to the second emitter during an evaluation step, as mentioned above.

In particular with regard to the optical separation of the emitters from one another, in some embodiments the fluorescence emission is measured in two detection channels which differ with regard to the spectral sensitivities, or in more than two channels or with high spectral resolution. If the detection is carried out in two channels in such embodiments, the spectral sensitivities of the detection channels and the first and second emitters are particularly matched to each other in such a way that a sensitivity of the first detection channel for emission of the second emitter is minimized in relation to the sensitivity for emission of the first emitter. In general, the aim is to minimize crosstalk between the emission of one emitter and the detection channel of the other emitter. Two detection channels can be provided, for example, by placing a color splitter in a detection beam path in which the emission is guided to a measuring device, which splits the detection beam path into two paths, with emitted light below a cut-off wavelength being guided in one of the paths and light above this cut-off wavelength being guided in the other and fed to an associated detector. If certain emitters, in particular certain fluorescence emitters, are used to mark structures of the sample, this cut-off wavelength can now be selected, for example by selecting a corresponding color splitter or by setting a color splitter with variable cut-off wavelength, so that a sensitivity of the first detection channel for an emission of the second emitter is minimal in relation to the sensitivity for an emission of the first emitter. Conversely, the emitters with which structures in the sample are marked can also be selected in such a way that the above condition is fulfilled when using a specific device with fixed color channels. Overall, in these embodiments, it may be advantageous to select emitters whose emissions differ spectrally as clearly as possible and to match the spectral detection channels to their spectral emission characteristics in order to fulfill the above condition. The above condition does not necessarily have to be strictly fulfilled. In some embodiments, the emitters and the spectral sensitivities of the detection channels are tuned such that a sensitivity of the first detection channel for emission of the second emitter is at most 10%, particularly at most 5%, of the sensitivity for emission of the first emitter, further particularly at most 1% of the sensitivity for the emission of the first emitter and/or that a sensitivity of the second detection channel for emission of the first emitter in relation to the sensitivity for emission of the second emitter is at most 10%, particularly at most 5%, further particularly at most 1% of the sensitivity for emission of the second emitter. In some embodiments, the spectral compositions of the first excitation light and the second excitation light and the first and second emitters can therefore be matched to each other in such a way that crosstalk of the emission of the second emitter into the detection channel for the first emitter is particularly low, while accepting that the crosstalk of the emission of the first emitter into the detection channel for the second emitter is higher. This applies in particular to those embodiments in which a location of the first emitter is determined in the location determination step and, on the basis of the location of the first emitter determined in the location determination step, a respective new assumed location range and a new set of courses of intensity increase regions or of positions of the intensity minimum are determined for each of the emitters. Detection in two spectral channels can be achieved by simple means and at the same time with high efficiency, i.e. with low losses of emitted light before detection.

In other embodiments, the emission is measured in more than two spectrally different channels, for example in three, five or more, ten or more channels. The spectral channels can partially overlap spectrally or be spectrally separated. For example, the emission light can be split by means of a diffraction grating or a prism or by means of corresponding devices known from the field of spectrometry and fed to an array, for example a row of detectors. However, it is also possible to cascade fixed or adjustable color splitters and in this way direct the emission light to a large number of individual detectors.

In some embodiments, the measured value of the emission of the first emitter is assigned to the first emitter when measuring the emission. Here, it may be advantageous to assign only those emissions to the first emitter that originate from the first emitter with a particularly high degree of certainty. Such an assignment is made possible, for example, by the above-mentioned and more detailed means that the first and second excitation light are different in terms of their spectral composition, that the fluorescence emission is measured in two detection channels, which differ in terms of spectral sensitivities, or in more than two channels, and that in the illumination and measurement step the illumination with the first excitation light and the illumination with the second excitation light are performed separately in time. These means can act cumulatively, for example by illuminating with the first excitation light and the second excitation light, which is spectrally different, at different times, whereby the fluorescence emission is measured in two detection channels, which differ in terms of spectral sensitivities, or in more than two channels. As mentioned above, a temporal resolution of the measurement can also be used to improve the assignment of measured emission values to the emitter from which the emission originates during data acquisition. However, a combination of, for example, illumination with first and spectrally different second excitation light and measurement of the fluorescence emission in two detection channels, which differ in terms of spectral sensitivities, or in more than two channels, is also advantageously possible if the illumination with first and second excitation light is not separated in time.

In embodiments in which the measured value of the emission of the first emitter is assigned to the first emitter when measuring the emission, the location of the first emitter can be determined on the basis of the measured values of the emission assigned to the first emitter. If, for example, fluorescence emitters are used as emitters, of which the first emitter has an emission spectrum with a maximum at a large wavelength and the second emitter has one at a small wavelength, the detection of the emission of the first emitter can be detected without large losses in such a spectral range that no or at least only negligibly little emission of the second emitter is detected in this spectral range, even if the second emitter is actually excited by the excitation light for the first emitter. If the measurement is carried out in this way, the location of the first emitter can therefore be determined in the location determination step with similar accuracy as it would be determined if there were no second emitter within the measurement area.

In some embodiments, when measuring the emission, measured values of the emission are assigned to the emitter from which the emission originates. Here it may be advantageous to assign only those emissions to the respective emitter that originate from the respective emitter with a particularly high degree of certainty. Several means that enable such an assignment are explained above in connection with an assignment of the emission of the measured values of the emission of the first emitter to the first emitter. In these embodiments, it may be advantageous that, in the location determination step, the locations of the first and second emitters are determined on the basis of the various positions and the assigned measured values of the emission, and that, on the basis of the locations of both emitters determined in the location determination step, a respective new assumed location range and, overall, a new set of courses of intensity increase regions or of positions of intensity minima are determined for each of the emitters.

In a particular embodiment, three spectral detection channels are used, whereby two of the channels, referred to here as channels A and B, are tuned to the emissions of the first and second emitter in such a way that in each of the two channels A or B, emissions of an assigned first or second emitter are detected exclusively or almost exclusively, so that emissions of the non-assigned second or first emitter contribute less than 1% or particularly less than 1% to the measurement signal in the respective spectral channel A or B. The spectral channels A and B then have a spectral distance from each other within which emissions are detected neither in channel A nor in channel B. The third of the channels, referred to here as channel C, is then set up to detect emissions in this spectral gap. Particularly, the spectral detection range of channel C fills the spectral gap. Such a detection arrangement is particularly advantageous because it enables the emissions detected in channels A and B to be assigned to the respective emitter with a high degree of certainty during data acquisition. This in turn enables the positions of both the first emitter and the second emitter to be determined using a MINFLUX method without the emissions of the second emitter interfering with the position determination of the first emitter and, conversely, without the emissions of the first emitter interfering with the position determination of the two emitters. It should be noted that in this way only a certain proportion of the total detected emissions is initially used for the position determination, which means that the position determination has a higher uncertainty. When carrying out the illumination and measurement steps, it is crucial that the positions are determined without a bias. This is the case here. The emission detected in the third channel can then be used in an evaluation step after data acquisition is complete to determine the trajectories of the first and second emitters with greater accuracy. Particularly, emissions detected in the third channel are classified for this purpose, i.e. assigned to the first or second emitter in each case. This can be done, for example, on the basis of a time-resolved detection in the third channel if the emitters have different lifetimes, or on the basis of a time-separated excitation with spectrally different first and second excitation light.

If the emissions are recorded in more than three spectral channels or with a higher spectral resolution, the principle of only using emissions that can be precisely assigned to one of the emitters for the duration of the data recording can also be implemented by selecting emissions from corresponding spectral ranges.

As part of the evaluation step, it is then possible, for example, when determining the trajectories of the individual emitters, to weight a measured emission and the course of an intensity increase region assigned to it or the position of an intensity minimum assigned to it according to the certainty with which the emission can be assigned to the relevant emitter. The corresponding weights can be obtained, for example, by means of a ratiometric evaluation of the total recorded measured values or a ratiometric evaluation of sections of the total recorded measured values. It may also make sense for weights that deviate from the value 1 to be used in the evaluation step only when determining the trajectory of one of the emitters, i.e. the first or the second emitter.

The methods according to the present disclosure can be used, for example, to investigate movements of structures, for example motor proteins, in a sample which are marked in at least two areas, for example if the structure is an elongated structure, at each end with one of the emitters, i.e. which are marked with both a first and a second emitter. In such a case, the first and second emitters are connected to each other by a structure. Such doubly marked structures, in particular biological structures whose movement is to be tracked by means of a method according to the present disclosure, regularly have an extension that is smaller than the diffraction limit, at least in one direction. If the movements of such structures are now tracked, it is sufficient to determine the location of the first emitter in a location determination step in order to track the movement of the structure and thus of both the first and the second emitter. Based on this location alone, a new assumed location range can be determined for each of the emitters and overall a new set of positions can be determined. This applies even if the structure is not rigid but deforms during tracking, as long as the distances between the emitters are fundamentally limited by the structure. Although separate trajectories are not recorded during tracking, the trajectory of the second emitter can be recorded as part of a subsequent evaluation step, i.e. a data analysis after tracking of the movement has ended. This is possible because an emission from the second emitter is also excited and measured in each of the illumination and measurement steps due to the close proximity of the two emitters, whereby a measured value of the emission is assigned to the position at which the illumination light is positioned. Due to the size of the structure, which is smaller than the diffraction limit, this second emitter is reliably located in an area that is illuminated by excitation light. For each of the emitters, a new assumed location range can now be determined. For the first emitter, the new assumed location range around the determined location can be determined depending on the expected uncertainty of the location determination or the uncertainty determined from the measured values, in particular the number of detected photons and the size and type of the predetermined set of positions. For the second emitter, the new assumed location range can be determined based on the assumed location range of the first emitter, for example depending on the size of the structure connecting the emitters or generally based on prior knowledge of the structure to which the emitters are coupled. Based on the new assumed location ranges of the first and second emitters, a new set of courses of intensity increase regions or of positions of the intensity minima is now determined as a whole. Such a set is particularly selected in such a way that it is possible to track the movement of the first emitter at high speed and with high accuracy and at the same time in such a way that a trajectory with high accuracy can also be determined for the second emitter as part of the data analysis after the end of the tracking of the movement.

In particular embodiments, a common mean location of both emitters can be determined in the location determination step based on the different positions and the associated measured values of the emission. In these embodiments, based on the common mean location of both emitters determined in the location determination step, a new assumed location range and a new set of positions in total are determined for each of the emitters. The assumed location ranges of the first emitter and the second emitter can be identical, but they can also differ. Different assumed location ranges can result, for example, if the contributions of the emitters to the measurement signal differ quantitatively. In this case, the assumed spatial range of the emitter with the higher contribution can be smaller than that of the emitter with the lower contribution. Knowledge that there are quantitatively different contributions can, for example, be based on prior knowledge about the emitters or on an evaluation of the measurement data.

Particularly, a common mean location of the first emitter and the second emitter is determined on the basis of the total of the emissions assigned to the associated courses. This also applies, for example, if emissions from the first and second emitters are measured in several different spectral channels. Then the measured values of the several spectral channels are combined to determine the common mean location of both emitters in a data set that represents the respective courses or the respective positions of the intensity minimum and associated emissions. In general, the fact that the totality of the emissions associated with the associated courses is used for the determination of the common mean location means that there is no assignment of the emissions to either the first emitter or the second emitter, which would be used in this context. This has the advantage, for example, that the method may be less sensitive to the effects of background emissions that do not originate from either the first or the second emitter.

In determining the assumed location ranges and determining the new set of courses or positions, it may now particularly be taken into account that the emitters are spaced apart and that neither the position of the first nor the second emitter has been estimated with the same accuracy that would have been obtained if all emissions had originated from a single emitter. In the case where the different courses are obtained by placing a minimum of a certain intensity distribution at different positions or where placing a minimum of an intensity distribution from different locations is part of the measures for obtaining different courses, taking into account the spacing of the emitters and the knowledge of the increased uncertainty of the knowledge of the locations of the individual emitters can be done by enlarging the assumed location ranges in accordance with the increased uncertainty and determining the sets of courses or positions adapted to the enlarged assumed location ranges. The same also applies if the determination of the assumed location ranges and the sets of courses is based on a determination of the location of the first emitter, but not of the second emitter. In this case, although under favorable circumstances the location of the first emitter can be known with similarly low uncertainty as in the absence of a second emitter, this uncertainty is usually increased. In addition, the location of the second emitter is known with less certainty in any case.

A distance between the two emitters, for example a maximum distance or an average or typical distance between the emitters, can in many cases be known before the tracking is carried out, as generally known structures are often specifically examined or as the sample may have been imaged for carrying out the tracking of the emitters. Accordingly, in the two aforementioned variants—determination of a common mean location of both emitters and determination of the location of the first emitter—the previously known distance can particularly be taken into account when determining the assumed location ranges and the following steps, for example in that the extent of the assumed location ranges around the determined common mean location or around the location of the first emitter is at least a multiple of this distance, for example at least four times or ten or fifty times the distance of the two emitters from one another.

In general, in embodiments in which the different courses of the intensity increase region are obtained by placing an intensity minimum of an intensity distribution at different positions, and in each of which a common mean location of both emitters is determined, it is advantageous that the predetermined set of positions comprises a first and a second position which have a distance from each other which is at least four times or ten or fifty times the distance of the two emitters from each other. In particular, if this distance between the emitters is not known from the outset, it may be advantageous that the predetermined set of positions comprises a first and a second position which are at least four or ten or fifty times the distance between the two emitters or at least 50 nm or at least 100 nm or at least 200 nm apart. The same applies to a new set of positions in each case. Also in other embodiments, in which a common mean location of both emitters is not determined, it may be advantageous that the predetermined set of positions comprises a first and a second position which are spaced apart according to the above.

The methods according to the present disclosure can be used, for example, to track movements of two emitters where the first and second emitters are at a distance from each other, which is less than 100 nm or less than 50 nm or less than 20 nm or less than 10 nm or even less than 5 nm.

Embodiments in which a location of the first emitter is determined in each case in the location determination step and new assumed location ranges of the first and second emitters are determined on the basis of this location, and embodiments in which a common mean location of both emitters is determined in each case and new assumed location ranges of the first and second emitters are determined on the basis of this location, are particularly advantageous if the emitters have distances of less than 50 nm or less than 20 nm or, in particular, less than 10 nm or even less than 5 nm from one another, especially if the emitters are coupled to a structure in such a way that the distance between the emitters can vary only slightly or not at all during the measurement period.

In methods in which predetermined sets of positions of an intensity minimum are utilized, it may be advantageous that the predetermined set of positions includes a first predetermined subset of positions located around a assumed location range of the first emitter and a second predetermined subset of positions located around a assumed location range of the second emitter. These subsets may be identical by chance or by design. In many cases, it is advantageous that the first predetermined subset of positions and the second predetermined subset of positions are different from each other. The same also applies to a new set of positions in each case.

If the predetermined set of positions comprises two subsets, in particular if it comprises two different subsets, it may be advantageous that in the illumination and measurement step, the local minimum of the first excitation light or the local minimum of the emission suppression light overlapping with the excitation light is positioned at the positions of the first predetermined subset of positions and the local minimum of the second excitation light or the local minimum of the emission suppression light, which overlaps with the second excitation light, is positioned at the positions of the second predetermined subset of positions. The same also applies in each case for a new set of positions if this also has corresponding subsets.

If the predetermined set of courses comprises two subsets, in particular if it comprises two different subsets, it may be advantageous, according to the case described above, that in the illumination and measurement step the courses of the first excitation light or the courses of the emission suppression light which overlaps with the first excitation light, are generated according to the first predetermined subset of courses and the courses of the second excitation light or the courses of the emission suppression light which overlaps with the second excitation light are generated according to the second predetermined subset of positions .. The same applies in each case to a new set of courses if this also has corresponding subsets.

In the two aforementioned cases, the more general one with two subsets of courses or the more specific one with two subsets of positions, it may be advantageous that in the illumination and measurement step, first the courses of the first excitation light or the courses of the emission suppression light overlapping with the excitation light are generated according to the first predetermined subset of courses, and then the courses of the second excitation light or an emission suppression light overlapping with the second excitation light are generated according to the second predetermined subset of courses, are generated according to the second predetermined subset of courses or that in the illumination and measurement step first the local minimum of the first excitation light or the local minimum of the emission suppression light overlapping with the excitation light is positioned at the positions of the first predetermined subset of positions and then the local minimum of the second excitation light or the focus of the second excitation light and the emission suppression light is positioned at the positions of the second predetermined subset of positions. More generally described, in these embodiments, the first subset of positions with the associated light or lights is processed first and then the second subset of positions is processed. It should be noted at this point that in certain embodiments, certain lights may be explicitly or implicitly assigned to the first and second subsets, for example long wavelength excitation light to the first subset and short wavelength excitation light to the second subset. With regard to these embodiments, it should be noted that in many cases the order in which the subsets are processed is not important; rather, the second subset with the associated light can also be processed first and then the first subset with the associated light.

In methods in which subsets are processed sequentially, it may be advantageous, in particular if in the method locations of the first and second emitters are determined in a location determination step, that after the courses of the first excitation light or the emission suppression light overlapping with the first excitation light have been generated according to the first predetermined subset of courses, within a period in which the illumination and measuring step is continued with the second excitation light, the location determination step is started on the basis of the different courses of the first predetermined subset of courses and the associated measured values of the emission, wherein a determination of the location of the first emitter is performed, the location determination step is started on the basis of the various courses of the first predetermined subset of courses and the associated measured values of the emission, wherein the location of the first emitter is determined, and a new assumed location range and a new first subset of the new set of courses are determined for the first emitter on the basis of the location of the first emitter determined in the location determination step, wherein the new first subset of courses comprises courses adapted to the new assumed location range of the first emitter. Again, in many cases it is not the order that matters. Rather, it is crucial that the two subsets are processed in such a way that a location determination step already begins with the determination of a location of the other emitter during data acquisition, i.e. during the execution of an illumination and measurement step in a period in which measurement data is obtained for one of the emitters. It is advantageous that this part of the location determination step, i.e. the determination of the location of the first emitter, viewed in terms of time, is completed while the illumination and measurement step is still in progress, and that a new first subset of courses, which is adapted to the determined location of the first emitter, is determined on the basis of the location of the first emitter while the illumination and measurement step is still in progress. In this case, the following illumination and measurement step can be carried out immediately after completion of the illumination and measurement step just considered, i.e. the repetition of the illumination and measurement step can already be started before the illumination and measurement step has been completed. The same applies, of course, if the different courses are generated by placing an intensity minimum at different positions for positions of the respective intensity minima.

In the case described above, it is further advantageous that after the courses of the second excitation light or the courses of the emission suppression light overlapping with the second excitation light are generated according to the second predetermined subset, within a time period in which the repeating of the illumination and measurement step is started with the first excitation light, the location determination step is completed based on the various courses of the second predetermined subset of courses and the associated measured values of the emission the location determination step is completed on the basis of the various courses of the second predetermined subset of courses and the associated measured values of the emission, the location of the second emitter being determined, and a new assumed location range and a new second subset of the new set of courses are determined for the second emitter on the basis of the location of the second emitter determined in the location determination step, the new second subset comprising courses adapted to the new assumed location range of the second emitter. Preferably, the new second subset is determined before the part of the repetition of the illumination and measurement step in which the first new subset is processed is completed. This measure also serves to speed up the data acquisition or, more precisely, to increase the temporal resolution with which the emitters are tracked.

When carrying out particular methods, a local minimum of an intensity distribution of illumination light with a local minimum is positioned in a measuring area in a temporal sequence at different positions of a predetermined set of positions. This can also mean that areas around positions of the predetermined set of positions are swept over in time intervals. The same also applies to a new set of positions. Similarly, in confocal microscopy, for example, the term “scanning at scanning positions” is used, even if a scanner actually moves the scanning beam continuously. The same applies to a set of courses of intensity increase regions. Here too, a course can vary within a time period assigned to a course of the set of courses, so that the course of the set of courses corresponds to an average of the actual courses over the time period. This is obviously the case if the different courses of the intensity increase region are generated by placing an intensity minimum of an intensity distribution at different positions. However, it also applies if the different courses are generated in other ways, for example by different modulations of a phase of a light beam in a pupil or in the vicinity of a pupil or by interference of partial beams whose phases are shifted relative to each other.

The fact that the local minimum is positioned at different positions of a predetermined set of positions around a assumed location range does not mean that the predetermined set exclusively contains positions around the assumed location range. Rather, such a set may also include positions within the assumed location range, such as in the center of the assumed location range, or the positions may fill the assumed location range in a grid-like manner. It is important for the implementation of these particular embodiments, that the local minimum is in any case also positioned at predetermined positions around the assumed location range. Furthermore, this also does not exclude that the minimum is placed, for example, along a continuous path, whereby a measured value of the emission is assigned in each case to the position of the continuous path at which the illumination light is positioned. This path can enclose the assumed location range or sweep over it. The same applies analogously for each new set of positions, i.e. for the repetition of the illumination and measurement step. Accordingly, a predetermined set of courses or a new set of courses may not contain only those courses that lie in an assumed location range of one of the emitters.

In general, it is advantageous that the local minimum of the intensity distribution of excitation light or emission suppression light is a zero point.

The local minimum can be a 3D minimum, a 2D minimum or a 1D minimum. What this means in each case is explained above in connection with definitions of terms. If a 3D minimum, a 2D minimum or a 1D minimum is used, the corresponding intensity increase regions are obviously also used. This is no longer explicitly mentioned in the following. When tracking the emitters, different types of minima as well as differently oriented minima, in particular differently oriented 1D minima, can be used. For example, a first 1D minimum oriented in a second direction can be used in an illumination and measurement step and the measurement data can be used to determine a position of the emitter along a first direction perpendicular to the second direction. A second 1D minimum oriented perpendicular to the first 1D minimum can be used both in the same illumination and measurement step and in a subsequent illumination and measurement step. If the second 1D minimum is placed in the same illumination and measurement step, this is done according to the predetermined set of positions associated with the illumination and measurement step. If, on the other hand, the second 1D minimum is placed in a subsequent illumination and measurement step, i.e. when the illumination and measurement step is repeated, this can be done according to a new set of courses or positions obtained from the aforementioned illumination and measurement step. The fact that a position obtained using the first minimum can be relevant for the placement of the second 1D minimum results from the properties of the minima, which have not yet been discussed in detail but are familiar to the person skilled in the art.

In particular embodiments, the 1D minimum and/or the 2D minimum and/or the 3D minimum are generated by modulating and focusing the light. The intensity distribution then fills a focal volume. As a rule, the intensity distribution in the focal volume, in which the aforementioned intensity increase regions are formed, is of particular interest. With increasing distance from the focus, i.e. from the center of the focal volume, along the orientation of the 1D minimum, the intensity increase regions become less pronounced. It is therefore desirable for a 1D minimum to be positioned in such a way that the intensity increase region that is used begins at the focus of the intensity distribution. The same applies to a 2D minimum, as will be clear to anyone skilled in the art.

Accordingly, a 2D minimum can also be used in conjunction with a 1D minimum to determine a position along the axis of the 2D minimum both in the same and in successive illumination and measurement steps. In this case, instead of a true 1D minimum, a minimum generated by means of an annular phase plate can be used, for example, which corresponds approximately to a 1D minimum in the vicinity of the focus. In this application, a minimum generated by means of an annular phase plate (and without a vortex phase plate) is therefore subsumed under the term 1D minimum.

Preferably, a 2D minimum can be used in conjunction with a corresponding 1D minimum in such a way that several or some illumination and measurement steps are carried out with a 2D minimum and occasionally, for example after fixed time intervals or when the movement of the emitters has been tracked over a predetermined extent, a 1D minimum is used. Such a procedure is suitable for many biological samples, as the movements to be observed in these often run almost in a plane parallel to the sample surface and only slightly in the direction perpendicular to it. In these cases, the use of the 1D minimum can serve in particular to ensure that the focus of the intensity distribution forming the 2D minimum is positioned axially in a suitable manner, in particular to improve the location determinations perpendicular to the axis of the 2D minimum.

In other cases, the movement of the first emitter and of the second emitter can be aligned with a structure in the sample. For example, motor proteins labeled with the first and second emitters, such as kinesins, can move along microtubules. Such microtubules can be imaged before tracking, for example using MINFLUX, so that their orientation in the sample is known. Then the sequence of using a 2D minimum and a 1D minimum can be chosen depending on this known position of the structure along which the emitters move.

Structures along which structures marked with a first and a second emitter move are often elongated, i.e. in such a way that the emitters move along a fixed path. As a result, in time periods during which several to some illumination and measurement steps with the associated further steps are carried out, both emitters move at least almost along a straight line. In such cases, it can be advantageous to use 1D minima that are aligned in such a way that the above-mentioned straight line is oriented normal to the plane along which the minimum of the intensity distribution extends. Since the structures are often aligned parallel to the sample surface, this can be achieved by using a device for rotating a linear polarization, a corresponding phase modulator and focusing the light forming the minimum into the sample. In this case, particularly after the emitters have moved a predetermined distance or after a fixed period of time, a measurement is performed using a differently oriented 1D minimum, particularly perpendicular to the first 1D minimum, or using several such 1D minima, for example one of them to determine the position along the optical axis, or using a 2D minimum or a 3D minimum to ensure that the emitters are within the focal range in further illumination and measurement steps, i.e. in subsequent repetitions of the illumination and measurement step, and to check the direction of movement or to determine a changed direction of movement. In subsequent illumination and measurement steps, i.e. in repetitions of the illumination and measurement step, the orientation of the 1D minimum can then be adapted to the new direction of movement. Such methods using minima oriented with regard to the alignment of a structure offer the advantage of a particularly high speed, because in the relevant steps, only one position along one direction needs to be inferred from the emissions.

Such methods using a 1D minimum can be designed both as MINFLUX methods and as STED-MINFLUX methods.

Such methods using a 1D minimum can be carried out using only one excitation light or using two, in particular different excitation lights.

Such methods using a 1D minimum can also focus on one of the two, i.e. the first and or the second emitter, while the other emitter is tracked using minima of a different type.

Such methods using a 1D minimum can be carried out in such a way that a of the first emitter is determined in a location determination step or that locations of the first and second emitters are determined in a location determination step or that a common mean location of both emitters is determined in a location determination step.

If different types of minima are used within an illumination and measurement step, this can be done in succession or interleaved in time, i.e. in such a way that different types of minima are used in rapid alternation so that the measurement information corresponding to the different minima is obtained virtually simultaneously. In conjunction with the use of pulsed light, minima of different types can be used “pulse interleaved”.

In particular embodiments, the first emitter or the second emitter or both emitters are fluorescence emitters. Here, the first emitter or the second emitter or both emitters can be fluorophores or units formed from fluorophores. The use of units formed from several fluorophores has the advantage that a larger measurement signal can be obtained. On the other hand, the use of individual fluorophores as emitters has the advantage that the range from which the fluorescence originates is limited to a minimum range, which has a beneficial effect on the resolution that can generally be achieved. Both the first emitter and the second emitter can be emitters which are excitable by multiphoton processes or particularly by single photon processes.

It may be particularly advantageous to use a single fluorophore as the first emitter and a unit formed from several fluorophores as the second emitter. This is particularly favorable if, in the location determination steps, a position of the first emitter is determined in each case on the basis of the emissions of the first emitter, i.e. in this case the individual fluorophore, whereby on the basis of this location a respective new assumed location range and overall a new set of courses of the intensity increase region or of positions of the intensity minimum are determined for each of the emitters. The larger obtainable measurement signal in the measurement of the emissions of the second emitter can then be used in particular in conjunction with a spatially resolved detection of the emissions in the detection plane, which resolves an Airy diameter of the point spread function of the image of a point source, and where the detector has a range greater than an Airy diameter, for example 1.5 Airy diameters or particularly 2 or more Airy diameters, can be used to also determine positions of emitters with high resolution which are captured by excitation light during the illumination and measurement steps but do not regularly lie within intensity increase regions. Such a case can occur, for example, if both emitters are excited with excitation light that is identical in terms of spectral distribution, for example with identical narrowband or monochromatic laser light, and the emitters are comparatively far apart, for example at a distance that corresponds to or is greater than the diffraction limit of the optical image, so that if the first emitter lies within an intensity increase region, the second emitter can lie in the region of a maximum of the excitation light distribution. Preferably, the detection is also spectrally separated in this case, so that the detection of fluorescent light from the first emitter is suppressed on the said spatially resolving detector. The emission from the second emitter can then be used to determine the position of the second emitter during the data acquisition process using the locations of the emissions on the spatially resolving detector, but the measured values are particularly suitable for determining a trajectory of the second emitter as part of an evaluation step after the data acquisition has been completed.

It may also be particularly advantageous to use a single fluorophore as the first emitter and a unit formed from several fluorophores as the second emitter if it is to be expected that the units labeled with the emitters, for example of a biological structure, or the units labeled with the emitters, for example biological structures, exhibit strongly fluctuating distances during the tracking of the emitters. Then, if the emitters have only small distances, excitation light can be used separately for the first emitter and for the second emitter, whereby both the first and the second emitter are each localized according to a MINFLUX method, while if the distance has grown in such a way that the second emitter comes into the area of influence of a maximum of the intensity distribution of the excitation light of the first emitter, the use of excitation light for the second emitter is dispensed with. This takes advantage of the fact that, due to the high intensities of the excitation light for the first emitter, a low cross-excitation can be sufficient to significantly excite the second emitter so that its position can be determined from its measurement signal. By dispensing with excitation light for the second emitter, whose intensity increase region is adapted to the position of the second emitter, it is ensured in this case that the first emitter does not come into the range of a maximum of the excitation light for the second emitter. To increase the measurement signal of the second emitter, which has the aforementioned large distance from the first emitter, an intensity distribution of excitation light for the second emitter can also be used, which is specifically placed according to a position of the first emitter, i.e. which has a minimum at the assumed location of the first emitter.

In further embodiments, the first or the second emitter or both emitters may be scattering emitters. If only one of the emitters is a scattering emitter, then the other emitter can be a fluorescence emitter. The two emitters can then be separated, for example, on the basis of the time interval between the measurement of an emission and an excitation, since scattering has no time delay. This is particularly advantageous if the excitation is pulsed. If both emitters are scattering emitters, the scattering properties of the two emitters must depend in different ways on the wavelengths of the excitation light. This can be achieved, for example, by selecting suitable nanoparticles. It is then necessary to use two spectrally different excitation lights. However, if a scattering emitter is used, it is advantageous if the other emitter is a fluorescence emitter. Furthermore, it is advantageous that the scattering emitter selectively scatters excitation light of a narrow wavelength range. Then the scattering emitter and the fluorescence emitter can each be excited separately, i.e. separated in time, which enables particularly good separation of the emissions and correspondingly particularly good assignment of the emissions to the associated emitter. This in turn favors that the method according to the present disclosure is carried out in such a way that the locations of the first and second emitters are determined in each of the location determination steps on the basis of the various courses of intensity increase regions and the associated measured values of the emission.

In particular embodiments, the sample can be illuminated in the illumination and measurement step with focused excitation light and an intensity distribution of emission suppression light with a local minimum in a measurement area, in particular with STED light. Various implementations are possible here. For example, a first excitation light that overlaps with an intensity distribution of a first emission suppression light, whereby the first excitation light and the emission suppression light are tuned to the first emitter, can be used in conjunction with a second excitation light that is tuned to the second emitter and forms an intensity minimum in the sample. In this case, the location of the first emitter can be determined using a MINFLUX method and that of the second emitter using a STED-MINFLUX method. If the emitters are fluorescence emitters and the fluorescence suppression light is STED light, then particularly the first emitter, or generally the emitter whose location is determined by means of STED-MINFLUX, is an emitter with a longer wavelength absorption maximum, i.e. it is determined by longer wavelength light, it is excited by longer-wavelength light, and the second emitter, or in general the emitter whose location is determined by means of MINFLUX, is an emitter with a shorter-wavelength absorption maximum, i.e. it is excited by shorter-wavelength light. In this way, the emitter whose location is determined using MINFLUX is prevented from being excited and/or bleached by the STED light for the other emitter.

In a particular embodiment, the emission suppression light may comprise wavelengths that suppress the emission of both emitters. For example, it may be narrowband or monochromatic light, in particular laser light, which suppresses the emission of both emitters. Even then, the first illumination light can be an excitation light that excites the light emission of both emitters, which means that the measurements of the emissions of both the first and the second emitter can be based on a common pair of excitation and emission suppression light, particularly based on a common pair of excitation and STED light. Alternatively, in the event that the emission suppression light comprises wavelengths that suppress the emission of both emitters, a first excitation light that is tuned to the first emitter, i.e. particularly excites it but not or only slightly excites the other, and a second excitation light that is tuned to the second emitter, i.e. particularly excites it but not or only slightly excites the other, can particularly be used.

The use of an emission suppression light that comprises wavelengths that suppress the emission of both emitters, in particular a corresponding narrowband or monochromatic laser light, in particular STED light, has the advantage, regardless of whether one excitation light or two excitation lights are used, that the location of both emitters is determined on the basis of the intensity courses of a single light, i.e. no deviations in the location determinations can occur due to a misalignment between two lights. The use of two different excitation lights matched to the respective emitters has the advantage that the separation of the two emitters is improved, i.e. the emissions can be assigned to the corresponding emitter with greater certainty. However, it should be noted that such STED-MINFLUX methods can also be used as methods in which the location of the first (but not the second) emitter or a common mean location of the first and second emitters can be determined in the location determination step. Only a combination of MINFLUX method and STED-MINFLUX method, as indicated above, is not suitable for carrying out the method according to the present disclosure in such a way that a common mean location of the first and second emitters is determined.

Preferably, once the tracking of the movement of the first and second emitters has been completed, an evaluation step is performed in which trajectories of the first and second emitters are determined on the basis of the measured emission values obtained in the repeated illumination and measurement steps and the assigned respective positions at which the illumination light was positioned. This evaluation step ensures a particularly high spatio-temporal resolution. In principle, the presence of two closely adjacent emitters reduces the spatio-temporal resolution with which each of the emitters can be tracked in real time, since emissions from one emitter increase the uncertainty with which the position of the other emitter can be determined. In the methods according to the present disclosure, in which an average position of both emitters is determined in each case, or in which the position of only one of the emitters is determined in the location determination step, from which new assumed location ranges of both emitters are then derived, it is obvious that at least the location range within which the second emitter lies with sufficient certainty is enlarged compared to location ranges determined by means of MINFLUX when only a single emitter is present under otherwise identical conditions. In this embodiment according to the present disclosure, use is now made of the fact that the trajectories do not have to be conclusively determined when the data acquisition is carried out. Rather, during data acquisition, it is only necessary to ensure that emissions are measured from both emitters that can be assigned to specific courses or positions of intensity minima. In certain embodiments, the assignment of emissions to the individual emitters can also be carried out for the first time in the aforementioned evaluation step. In embodiments in which emissions are already assigned to an emitter during data acquisition, such an assignment can be changed during the evaluation step.

In such an evaluation step, an influence of the neighborhood of an emitter on the emission of the respective other emitter that depends on the distance can be taken into account when determining the trajectories. In particular, the influence of a Forster resonance energy transfer (FRET) between a first and a second fluorescence emitter, especially between a first and a second fluorophore, can be taken into account. This applies in particular if, during the illumination and measurement steps, emissions from the fluorescence emitters are detected in several spectral channels or spectrally resolved and, in addition, either an excitation light is used that strongly excites a first emitter, which acts as a donor, but does not or only slightly excites a second emitter, which acts as an acceptor, or if a first excitation light and an excitation light spectrally separated from the first excitation light are used, the excitation lights being matched to the donor and the acceptor in such a way that the acceptor is excited as little as possible by the excitation light for the donor, conversely the donor is not or only very little excited by the excitation light for the acceptor. The latter requirement can be easily fulfilled for many FRET pairs, since in FRET pairs consisting of two fluorophores, the maximum of the excitation spectrum of the acceptor regularly lies at wavelengths at which the absorption of the donor is negligible; specifically, this excitation maximum lies at longer wavelengths than the emission maximum of the donor. When FRET occurs, fluorescence of the acceptor is detected depending on the distance, the smaller the distance, the more fluorescence is detected when excitation occurs exclusively with the excitation light for the donor. Conversely, the smaller the distance, the less fluorescence of the donor is detected.

In addition, the proximity of two fluorophores has an effect on fluorescence lifetimes under certain circumstances, for example on the fluorescence lifetime of the donor when FRET occurs. In the determination, the effects of a neighborhood can therefore already be taken into account under suitable conditions if the measurement of the emission of at least one of the emitters is time-resolved.

If the two closely adjacent emitters form a FRET pair, it may be sufficient to use an excitation light that excites the acceptor but not the donor, especially if both emitters are connected to a structure in such a way that FRET occurs during the entire measurement period of interest. In such embodiments, it may then be particularly advantageous that a common mean location of both emitters is determined during the location determination step. In this case, the assumed location range that is determined for the first emitter in each case can be identical to the assumed location range that is determined for the second emitter. Advantageously, however, two excitation lights can also be used to track the individual emitters of FRET pairs, which are matched to each other as described above. This is particularly advantageous if the distance between the emitters is so large during the measurement period of interest that no FRET occurs. It is then possible to determine separately assumed location ranges for each of the emitters during the entire measurement period in the respective location determination steps.

In the evaluation step, the trajectories of the first and second emitters can particularly be determined by means of a maximum likelihood method or by means of an error squared minimization method. Such methods are known to the skilled person and are referred to and explained in the state of the art cited in this application.

In the evaluation step, the measured emission values can be assigned to the respective emitters on the basis of a ratiometric evaluation of the measured emission values obtained in the repeated illumination and measurement steps.

In the evaluation step, the trajectories of the first and second emitters can particularly be determined on the basis of a model or the trajectories of the first emitter and the second emitter can be determined using a method that is calibrated on the basis of simulations. Preferably, both measures can also be combined, i.e. a model can be used that is calibrated using simulations. The simulations themselves can in turn be based on measurement data, for example on measurement data for recording the intensity distributions in a sample.

The present disclosure is further directed to a device, in particular to a microscope, which is set up in such a way that a method according to the present disclosure can be carried out.

The device has at least one light source. Preferably, this light source is a laser, more particularly a pulsed laser. Preferably, the light source is set up to generate broadband light, wherein the light source or the device is then particularly further set up so that different spectral ranges can be selected, so that different excitation lights and/or an excitation light and an emission suppression light, particularly a STED light, and/or different emission suppression lights, particularly STED lights, are provided, and/or the device has several light sources, particularly lasers, particularly STED lights, and/or the device has several light sources, particularly lasers, further particularly pulsed lasers, further particularly both pulsed lasers and cw lasers, so that different excitation lights and/or an excitation light and an emission suppression light, particularly an STED light, and/or different emission suppression lights, particularly STED lights, are provided in the device.

The presence of one or more cw lasers as well as one or more pulsed lasers is advantageous here, because MINFLUX processes are often more favorably performed with cw light and STED processes and thus also STED-MINFLUX processes are often more favorably performed with pulsed light. The presence of both laser types therefore enables both MINFLUX processes and STED-MINFLUX processes to be carried out with the most suitable types of light (pulsed or cw).

In order to carry out MINFLUX methods or STED-MINFLUX methods, an imaging objective is not necessarily required, since the high spatial resolution is not based on a high spatial resolution image of the light emitted from the sample, but on the type of illumination. Accordingly, the device must be set up to actually generate the intensity distributions or courses to be produced when carrying out a method according to the present disclosure and to detect the light emitted from the sample.

Accordingly, the device according to the present disclosure has an illumination device which is set up to influence light from the light source in such a way that the light directed into the sample forms an intensity distribution with a local minimum and adjacent intensity increase regions in the sample in a measuring area.

Accordingly, the device according to the present disclosure further comprises a light influencing device which is set up to generate different courses of intensity increase regions in the sample. In particular, the light influencing device can be set up to shift the local minimum with respect to the sample. The light influencing device can be an integral part of the illumination device

Furthermore, the device according to the present disclosure has a measuring device which is set up to detect emissions from the area of the sample in which a first and a second emitter, the first and the second emitter being closely adjacent, are excited, i.e. from the measuring area. The measuring device is also particularly set up to detect emissions in several spectral channels or with spectral resolution. Preferably, it has a color splitter for this purpose, more particularly a variable color splitter or a cascade of several variable color splitters.

Preferably, the device has an objective that is set up to direct light from the light source into a sample and to collect light emitted from the sample. This enables the device to also be used for carrying out other procedures, for example confocal microscopy or STED microscopy.

Preferably, the measuring device is set up to measure light emitted from the sample and collected by the objective. Preferably, this objective is located in the light path of both the illumination device and the measuring device.

Preferably, the light influencing device comprises a displacement device. The displacement device then particularly comprises one or more scanners, for example galvo scanners or electro-optical scanners.

Furthermore, the device according to the present disclosure has a memory unit which is set up to store positions of the local minimum and associated measured values.

Furthermore, the device according to the present disclosure has an evaluation unit which is set up to evaluate measured values assigned to courses of intensity increase regions or positions of the local minimum, wherein, on the basis of the various courses or positions and the associated measured values of the fluorescence emission, either i) a location of the first emitter or ii) locations of the first and the second emitter or iii) a common mean location of both emitters is determined and, on the basis of i) the determined location of the first emitter or ii) on the basis of the determined locations of both emitters or iii) on the basis of the determined common mean location of both emitters, a respective location range and, based thereon, a set of courses of intensity increase regions or of positions of the local minimum are determined for each of the emitters.

The device according to the present disclosure has a control unit which is set up to control the light-influencing device, whereby different courses of intensity increase regions in the sample are generated according to the set of courses, in particular whereby the local minimum is shifted to the positions of the determined set of positions.

Furthermore, the device according to the present disclosure has a control unit which is set up to control the device by means of which the local minimum can be displaced with respect to the sample.

Further advantageous elements are described in connection with the description of the methods. The technical means and elements mentioned there can be advantageously integrated in the microscope according to the present disclosure.

1.-25. (canceled)

26. A method for simultaneously tracking the movements of a first isolated emitter and a second isolated emitter, which is optically distinguishable from the first emitter, by means of a MINFLUX method or a STED-MINFLUX method, wherein the first and second emitters are closely adjacent, in a sample comprising the steps:
a) an illumination and measurement step in which the sample is illuminated with intensity distributions of excitation light or of emission suppression light overlapping with excitation light, which have a local minimum and intensity increase regions adjacent to the minimum in a measurement area, wherein different courses of intensity increase regions of a predetermined set of courses of intensity increase regions in an assumed location range of at least the first emitter and optionally of courses of intensity increase regions in an assumed location range of the second emitter are generated in a temporal sequence and emissions of the first emitter and optionally of the second emitter are measured, wherein measured values of the emission are assigned to the respective courses of intensity increase regions, and
b) a location determination step in which either i) a location of the first emitter or ii) locations of the first and second emitters or iii) a common mean location of both emitters is determined on the basis of the different courses of intensity increase regions and the associated measured values of the emission,
c) wherein on the basis of i) the location of the first emitter determined in the location determination step or ii) the locations of both emitters determined in the location determination step or iii) the common mean location of both emitters determined in the location determination step, a respective new assumed location range and in total a new set of courses are determined for each of the emitters, and
d) wherein the illumination and measurement step and the location determination step are repeated using a new set intensity increase regions.

27. The method according to claim 26, wherein the excitation light of the illumination and measurement step comprises first excitation light for exciting the first emitter and second excitation light for exciting the second emitter.

28. The method according to claim 27, wherein the first and the second excitation light are different with respect to their spectral composition, in particular wherein in the illumination and measurement step the illumination with the first excitation light and the illumination with the second excitation light are performed separately in time.

29. The method according to claim 26, wherein the local minimum is a 3D minimum or that the local minimum is a 2D minimum or that the local minimum is a 1D minimum, in particular wherein in the illumination and measurement step alternately minima of different types and/or differently oriented minima are used and/or that the illumination and measurement step is performed and repeated using alternately minima of different types and/or differently oriented minima.

30. The method according to claim 26, wherein the excitation light is pulsed, in particular wherein the measurement of the emission excited by a respective pulse is time-resolved, further in particular with a time resolution better than 1 ns, further particularly better than 100 ps, even more particularly better than 30 ps.

31. The method according to claim 27, wherein, in the location determination step, the locations of the first and second emitters are determined on the basis of the different courses and the associated measured values of the emission, and in that, on the basis of the locations of both emitters determined in the location determination step, a respective new assumed location range and a new set of courses as a whole are determined for each of the emitters.

32. The method according to claim 31, wherein the predetermined set of courses comprises a first predetermined subset of courses adapted to an assumed location range of the first emitter and a second predetermined subset of courses adapted to an assumed location range of the second emitter, in particular wherein the first predetermined subset of courses and the second predetermined subset of courses are different from each other, further in particular wherein, in the illumination and measurement step, the courses of the first excitation light or the courses of the emission suppression light overlapping with the first excitation light are generated according to the first predetermined subset of courses and the courses of the second excitation light or courses of an emission suppression light overlapping with the second excitation light are generated according to the second predetermined subset of positions.

33. The method according to claim 32, wherein in the illumination and measuring step, first the courses of the first excitation light or the courses of the emission suppression light overlapping with the excitation light are generated according to the first predetermined subset of courses, and then the courses of the second excitation light or an emission suppression light overlapping with the second excitation light are generated according to the second predetermined subset of courses.

34. The method according to claim 33, wherein after the courses of the first excitation light or the emission suppression light overlapping with the first excitation light have been generated according to the first predetermined subset of courses, within a time period in which the illumination and measurement step is continued with the second excitation light, the location determining step is started on the basis of the different courses of the first predetermined subset of courses and the associated measured values of the emission, wherein the location of the first emitter is determined, and a new assumed location range and a new first subset of the new set of courses are determined for the first emitter on the basis of the location of the first emitter determined in the location determination step, wherein the new first subset of courses comprises courses adapted to the new assumed location range of the first emitter.

35. The method according to claim 26, wherein, in the location determination step, the location of the first emitter is determined on the basis of the various courses and the associated measured values of the emission, and in that, on the basis of the location of the first emitter determined in the location determination step, a respective new assumed location range and overall a new set of courses are determined for the first emitter and for the second emitter.

36. The method according to claim 35, wherein the first and second emitters are connected to each other by a structure, in particular a biological structure, to which they are coupled as a marker.

37. The method according to claim 36, wherein the new assumed location range for the second emitter is determined on the basis of the location of the first emitter determined in the location determination step and on the basis of prior knowledge of the structure to which the emitters are coupled.

38. The method according to claim 26, characterized that, in the location determination step, a common mean location of both emitters is determined on the basis of the various courses and the associated measured values of the emission, and in that, on the basis of the common mean location of both emitters determined in the location determination step, a respective new assumed location range and a new set of courses as a whole are determined, in particular the first and the second emitter having a distance from one another which is smaller than 100 nm or smaller than 50 nm or smaller than 20 nm or smaller than 10 nm or smaller than 5 nm.

39. The method according to claim 38, wherein the common mean location of both emitters is determined on the basis of the totality of the measured values of the emission of the first emitter and of the second emitter of the illumination and measurement step.

40. The method according to claim 26, wherein the different courses of intensity increase regions are obtained by placing a minimum of an intensity distribution at different positions such that a set of courses corresponds to a set of positions of the minimum, in particular wherein the set of positions comprises a first and a second position which are at least four times or ten times or fifty times the distance of the two emitters from each other or at least 50 nm or at least 100 nm or at least 200 nm apart.

41. The method according to claim 26, wherein the first and/or the second emitter is a fluorescence emitter, in particular wherein the first and/or the second fluorescence emitter is a fluorophore or a fluorescent unit formed from fluorophores.

42. The method according to claim 28, wherein the spectral compositions of the first excitation light and of the second excitation light and the first and the second emitter are matched to one another in such a way that excitation of the second emitter by the first excitation light is minimal in relation to excitation of the first emitter by the first excitation light or, with the same excitation intensity, is at most 10%, particularly at most 5%, further particularly at most 1%, still more particularly at most 0.1% of the excitation of the first emitter, and/or in that the spectral compositions of the first excitation light and of the second excitation light and the first and second emitters are matched to one another in such a way that excitation of the first emitter by the second excitation light is minimal or, in particular, at the same excitation intensity is at most 5%, particularly at most 1%, still more particularly at most 0.1% of the excitation of the second emitter.

43. The method according to claim 26, wherein the fluorescence emission is measured in two detection channels which differ with respect to the spectral sensitivities, in particular wherein the spectral sensitivities of the detection channels and the first and the second emitter are matched to each other such that a sensitivity of the first detection channel for emission of the second emitter in relation to the sensitivity for emission of the first emitter is minimal or at most 10%, particularly at most 5%, more particularly at most 1% of the sensitivity for the emission of the first emitter t, and/or that the spectral sensitivities of the detection channels and the first and second emitters are matched to one another in such a way that a sensitivity of the second detection channel for emission of the first emitter is minimal in relation to the sensitivity for emission of the second emitter or is at most 10%, particularly at most 5%, more particularly at most 1% of the sensitivity for emission of the second emitter.

44. The method according to claim 26, wherein, after an end of the tracking of the movement of the first and of the second emitter, trajectories of the first and second emitters are determined in an evaluation step on the basis of the measured values of the emission obtained in the repeatedly performed illumination and measurement steps and the associated respective courses which had been generated.

45. The method according to claim 44, wherein when determining the trajectories, a distance-dependent influence of the proximity of one emitter on the emission of the respective other emitter, if present, in particular a Forster resonance energy transfer, is taken into account.

46. The method according to claim 26, wherein the sample is illuminated in the illumination and measurement step with focused excitation light and an intensity distribution of emission suppression light, in particular STED light, having a local minimum in a measurement range, the emission suppression light comprising wavelengths which suppress the emission of both emitters.

47. A microscope for simultaneously tracking the movements of a first isolated emitter and a second isolated emitter, which is optically distinguishable from the first emitter, by means of a MINFLUX method or a STED-MINFLUX method, wherein the first and second emitters are closely adjacent, comprising
a light source,
an illumination device which is set up to influence light from the light source in such a way that the light directed into the sample forms an intensity distribution with a local minimum in the sample in a measuring range,
a light influencing device, which is set up to generate different courses of intensity increase regions in the sample, wherein the light influencing device can be an integral component of the illumination device,
a measuring device that is set up to detect emissions from the measuring range,
an objective in the light path of both the illumination device and the measuring device, which is arranged to direct light from the light source into a sample and to collect light emitted from the sample,
a memory unit which is set up to store positions of the local minimum and associated measured values,
an evaluation unit which is set up to evaluate measured values assigned to courses of intensity increase regions or positions of the local minimum, wherein, on the basis of the various courses or positions and the associated measured values of the fluorescence emission, either i) a location of the first emitter or ii) locations of the first and second emitters or iii) a common mean location of both emitters is determined and on the basis of i) the determined location of the first emitter or ii) on the basis of the determined locations of both emitters or iii) on the basis of the determined locations of the second emitter or iii) on the basis of the determined locations of both emitters emitter or ii) on the basis of the determined locations of both emitters or iii) on the basis of the determined common mean location of both emitters, a respective location range is determined for each of the emitters and, based thereon, a set of courses of intensity increase regions or of positions of the local minimum,
a control unit arranged to control the light influencing device, wherein different courses of intensity increase regions in the sample are generated according to the set of courses, in particular wherein the local minimum is shifted to the positions of the determined set of positions.
